(19) United States
(12) Patent Application Publication
(10) Pub. No.: US 2007/0046011 A1
(43) Pub. Date: Mar. 1, 2007

(54) Static-type antiskid counter weight apparatus for a motor vehicle

(76) Inventor: Jamie J. Bovy, Bloomington, MN (US)

Correspondence Address: JAMES RAY & ASSOCIATES, 2640 PITCAIRN ROAD, MONROEVILLE, PA, 15146, US

(21) Appl. No.: 11/511,100

(22) Filed: Aug. 28, 2006

Related U.S. Application Data
(60) Provisional application No. 60/711,745, filed on Aug. 26, 2005.

(51) Int. Cl. B60S 9/00

(52) U.S. Cl. 280/759

(57) ABSTRACT

The invention provides a static-type antiskid counter weight apparatus which is used in a cargo compartment of a motor vehicle for improving traction of such motor vehicle during adverse weather conditions. Such cargo compartment having a bed, a pair of upwardly disposed side walls, each having a bracket attached thereto adjacent each end thereof, and a pair of wheel wells. The apparatus includes a pair of panels each positioned in a vertical plane adjacent a respective one of such pair of side walls and having a cut-out which is sized to fit over the wheel well. A system of locking karabiners and U-shaped retainers is provided for removably securing each panel to the respective side wall.

### CROSS-REFERENCE TO RELATED APPLICATIONS

This application is related to and claims priority from Provisional Patent Application Ser. No. 60/711,745 filed Aug. 26, 2005.

### FIELD OF THE INVENTION

The present invention relates, in general, to static-type antiskid counter weights for motor vehicles and, more particularly, this invention relates to an antiskid counter weight apparatus for use in cargo beds of pick-up trucks and the like.

### BACKGROUND OF THE INVENTION

As is generally well known, drivers experience difficulties with maintaining proper traction while driving an empty pick-up truck and other like motor vehicles in adverse weather conditions and, particularly, in adverse winter weather conditions.

Efforts have been made to improve traction of pick-up truck other similar type vehicles during adverse winter weather conditions. U.S. Pat. No. 6,302,464 to Kubis et al, U.S. Pat. No. 6,079,741 to Maver, and U.S. Pat. No. 5,494,315 to Heltneburg disclose ballast type devices which include hollow containers positioned over the wheel wells of such pick-up trucks and filled with sand or liquid to increase the weight over the rear axle of the pick-up truck. However, these devices are usually secured to the bed of the cargo compartment and therefore require structural modifications of the cargo portion. Furthermore, a greater than desirable effort is required to fill and empty such containers. Additionally, the containers which protrude into the interior portion of the cargo compartment reduce its usable width above the wheel wells.

U.S. Pat. No. 4,971,356 to Cook and U.S. Pat. No. 4,902,038 to Grover disclose a plurality of shaped units that are interlocked with each other to form one unit which will lay flat on the bed of the pick-up truck. However, use of such plurality of units increases their installation and removal effort.

### SUMMARY OF THE INVENTION

The present invention provides a static-type antiskid counter weight apparatus which is used in a cargo compartment of a motor vehicle for improving traction of such motor vehicle during presence of adverse weather conditions. The cargo compartment has a bed, a pair of upwardly disposed side walls each having a bracket attached thereto adjacent each end thereof and a pair of wheel wells. The apparatus includes a pair of panels each sized to fit a respective one of such pair of side walls. A cutout is provided in each panel which is sized to fit over the wheel well. A system of locking karabiners and U-shaped retainers is provided for removably securing each panel to such respective side wall.

### OBJECTS OF THE INVENTION

It is, therefore, one of the primary objects of the present invention to provide a static-type antiskid counter weight apparatus for improving traction of a motor vehicle during adverse weather conditions.

Another object of the present invention is to provide a static-type antiskid counter weight apparatus for improving traction of a motor vehicle which does not require modifications to such motor vehicle.

Yet another object of the present invention is to provide a static-type antiskid counter weight apparatus for improving traction of a motor vehicle which is simple and economical to manufacture.

A further object of the present invention is to provide a static-type antiskid counter weight apparatus for improving traction of a motor vehicle which is simple to install and remove.

Yet a further object of the present invention is to provide a static-type antiskid counter weight apparatus for improving traction of a motor vehicle which optimizes a usable width of the cargo compartment.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a static-type antiskid weight apparatus constructed according to a first embodiment of the invention;

FIG. 2 is a cross-sectional view of the static-type antiskid weight apparatus taken along the lines 2-2 of FIG. 1, constructed according to a second embodiment of the invention; and

FIG. 3 is a front elevation view of the static-type antiskid weight apparatus constructed according to a third embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

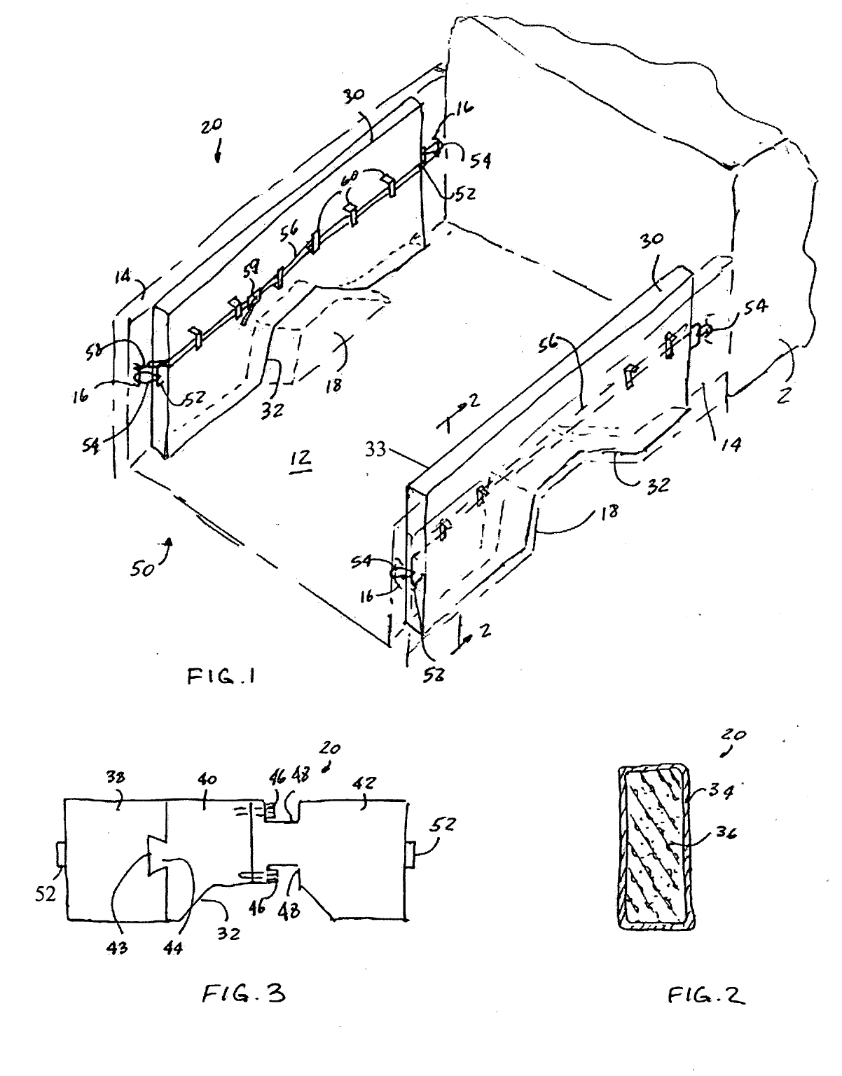

Reference is now made, to FIGS. 1-3, wherein there is shown a static-type antiskid counter weight apparatus, generally designated as 20, for use in a cargo compartment 10 of a motor vehicle 2, such as a pick-up truck. The apparatus 20 is used for improving traction of such motor vehicle 2 during adverse weather conditions. Such cargo compartment 10 has a bed 12, a pair of upwardly disposed side walls 14 each having a bracket 16 attached thereto adjacent each end thereof and a pair of wheel wells 18.

The apparatus 20 includes a pair of panels 30 each positioned in a vertical plane adjacent a respective one of such pair of side walls 14 and having a cut-out 32 sized to fit over such wheel well 18. Preferably, height and length of each panel 30 are approximately equal to the respective height and width of the side wall 14.

The size and weight of each panel 30 are predetermined to improve traction of the motor vehicle 2 during adverse weather conditions and, particularly, adverse winter weather conditions. Furthermore, it is desired for each panel 30 to have a width which is less than the width of such wheel well 18 in order to increase available width of the cargo compartment 10 as compared with most prior art devices. Accordingly, it has been found that panel 30 being approximately 2 inches wide, 18 inches high and about 38 inches long and weighing approximately 250 pounds improves traction of most pick-up trucks while optimizing available width of the cargo compartment 10, particularly above the wheel wells 18.

According to one embodiment of the invention, each panel 30 is preferably cast or machined as a unitary member from a metallic material. When the panel 30 is manufactured from a metallic material, a coating 33, such as rubber or plastic, is applied to the panel 30 to at least minimize damage to the cargo compartment 10 and to any load that may come in contact with each panel 30. Although, each panel 30 has been illustrated in FIG. 1 as having a uniform width, it would be apparent to those skilled in the art that each panel 30 may incorporate sections of different widths. This will be advantageous in positioning a greater weight directly over a rear axle or toward the rear of the cargo compartment 10.

According to another embodiment of the invention, best shown in FIG. 2, each panel 30 includes a hollow casing 34 which is filled with a weighty material 36. Such weighty material may be, for example, sand. Advantageously, the hollow casing 34 is formed from a plastic material.

According to yet another embodiment of the invention, the panel 30 may be formed from at least a pair of sections to enable ease of installation and removal by a single person without the need for assistance. By way of example, refer to FIG. 3, wherein such panel 30 is shown as being formed by a trio of sections 38, 40, and 42 and the apparatus 20 further includes means for removably joining adjacent sections.

Such joining means may include a generally dovetail tendon 43 formed in one section and a complimentary shaped mortise 44 formed in an opposed section. Or, such joining means may include a pair of threaded fasteners 46 and a pair of recesses 48 formed in one of the sections for positioning such pair of fasteners 46 within a peripheral boundary of the panel 30.

The apparatus 20 further includes means, generally designated 50, for removably securing each panel 30 to such respective side wall 14.

In the presently preferred embodiment of the invention, the securing means 50 includes a plurality of U-shaped retaining means 52 each attached to a respective end of each panel 30 and a plurality of karabiner type locking fasteners 54 each securing a respective one of the plurality of U-shaped retaining means 52 to a respective side wall bracket 16.

The securing means 20 may alternatively, or additionally, include a strap means 56 engageable with an exposed surface of the panel 30 and having a pair of hook means 58 each rigidly attached to a respective end of the strap means 56 for engagement with such respective side wall bracket 16. The strap means 56 may be manufactured from a reinforced fabric or rubberized material. A tension adjustment means 59, such as a well known buckle, may be provided for adjusting tension of the strap means 56 during installation of the panel 30. When the strap means 56 is manufactured form a rubberized material such tension adjustment means 59 may be provided by properties of such rubberized material.

The securing means 50 may further include a plurality of L-shaped retainers 60 attached to the exposed surface of the panel 30 and arranged in a linear pattern for retaining the strap means 56 on such exposed surface. Preferably, a long leg of a first portion of such plurality of L-shaped retainers 60 is oriented upwardly and a long leg of a second portion of such plurality of L-shaped retainers 60 is oriented downwardly.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A static-type antiskid counter weight apparatus for use in a cargo compartment of a motor vehicle for improving traction of such motor vehicle during adverse weather conditions, such cargo compartment having a bed, a pair of upwardly disposed side walls each having a bracket attached thereto adjacent each end thereof and a pair of wheel wells, said apparatus comprising:
(a) a pair of panels each positioned in a vertical plane adjacent a respective one of such pair of side walls and having a cut-out which is sized to fit over a wheel well; and
(b) a securing means for securing said each panel to such respective side wall.

2. The apparatus, according to claim 1, wherein said securing means includes a plurality of U-shaped retaining means each attached to a respective end of said each panel and a plurality of karabiners each securing a respective one of said plurality of U-shaped retaining means to a respective side wall bracket.

3. The apparatus, according to claim 1, wherein said securing means includes a strap means engageable with an exposed surface of said each panel and having a pair of hook means each rigidly attached to a respective end of said strap means for engagement with such respective side wall bracket.

4. The apparatus, according to claim 3, wherein said securing means further includes a plurality of L-shaped retainers attached to said exposed surface of said panel and arranged in a linear pattern for retaining said strap means on said exposed surface.

5. The apparatus, according to claim 4, wherein a long leg of a first portion of said plurality of L-shaped retainers is oriented upwardly and a long leg of a second portion of said plurality of L-shaped retainers is oriented downwardly.

6. The apparatus, according to claim 1, wherein said each panel is cast as a unitary member from a metallic material.

7. The apparatus, according to claim 6, wherein said apparatus includes a coating applied to said each panel for protecting such cargo compartment and a cargo positioned therein from damage due to contact with said each panel.

8. The apparatus, according to claim 1, wherein said panel includes a hollow casing which is filled with a weighty material.

9. The apparatus, according to claim 8, wherein said weighty material is sand.

10. The apparatus, according to claim 8, wherein said hollow casing is formed from a plastic material.

11. The apparatus, according to claim 1, wherein a width of said each plate is less than a width of such wheel well.

12. The apparatus, according to claim 1, wherein said each panel includes at least a pair sections and means for removably joining each of said at least a pair of sections together.

13. The apparatus, according to claim 12, wherein said joining means includes a pair of threaded fasteners and a pair of cut-outs formed in one section each receiving a respective one of said pair of threaded fasteners for positioning said pair of threaded fasteners within a peripheral boundary of said each panel.

14. The apparatus, according to claim 12, wherein said joining means includes a generally dovetail tenon formed in one of said at least a pair of sections and a complimentary shaped mortise formed in an opposed one of said at least pair of sections.

15. A method of improving traction of a motor vehicle during adverse weather conditions, such motor vehicle having a cargo compartment characterized by a bed, a pair of upwardly disposed side walls each having a bracket attached thereto adjacent each end thereof and a pair of wheel wells, said method comprising the steps of:
(a) providing a pair of panels each having each of a predetermined size and a predetermined weight and further having a cut-out which is sized to fit over a respective wheel well;
(b) positioning each panel in a vertical plane adjacent a respective side wall; and
(c) securing said each panel to a pair of brackets of said respective side wall.
